(19) United States
(12) Patent Application Publication
(10) Pub. No.: US 2015/0356152 A1
(43) Pub. Date: Dec. 10, 2015

(54) TEXT MINING DEVICE, TEXT MINING METHOD, AND RECORDING MEDIUM

(71) Applicant: NEC CORPORATION, Tokyo (JP)

(72) Inventors: Masaaki TSUCHIDA, Tokyo (JP); Kai ISHIKAWA, Tokyo (JP); Takashi ONISHI, Tokyo (JP)

(21) Appl. No.: 14/759,264

(22) PCT Filed: Jan. 10, 2014
(86) PCT No.: PCT/JP2014/050333

§ 371 Date: Jul. 6, 2015

(30) Foreign Application Priority Data
Jan. 11, 2013 (JP) 2013-003990

(51) Int. Cl. G06F 17/30

(52) U.S. Cl. CPC G06F 17/30539; G06F 17/3053; G06F 17/30598; G06F 17/30554

(57) ABSTRACT

A text mining device includes: an analysis unit which acquires, from data including text and one or more attributes including an attribute name and an attribute value and associated with the text, the attributes as analysis viewpoints, analyzes the data using the respective analysis viewpoints to obtain an analysis result from each analysis viewpoint, and generates result vectors of the respective analysis viewpoints; a similarity acquisition unit which acquires a vector similarity between the result vectors of the plural analysis viewpoints; and a recommendation unit which extracts and output a combination of the analysis viewpoints as a recommendation candidate on basis of the vector similarity.

### TECHNICAL FIELD

The present invention relates to text mining device, text mining system, text mining method, and recording medium.

### BACKGROUND ART

Text mining is data mining for text. As one of techniques for text mining, a technology for grasping a feature unique to a result of analysis based on each analysis viewpoint by comparing results of analysis based on a plurality of analysis viewpoints, has been conventionally known. Such a technology is disclosed in, for example, Patent Literature 1.

A text sorting device of Patent Literature 1 analyzes data including text and attributes. When a user selects arbitrary attributes, the text sorting device acquires, as analysis viewpoints, attribute values included in the attributes, and displays an analysis result from each of the analysis viewpoints.

### CITATION LIST

### Patent Literature

PTL 1: Japanese Patent Laid-Open No. 2004-164137

### SUMMARY OF INVENTION

### Technical Problem

When data is analyzed using the text sorting device of Patent Literature 1, an analysis result in the case of adopting, as an analysis viewpoint, an arbitrary attribute value included in an attribute that is selected by a user, and an analysis result in the case of adopting, as an analysis viewpoint, another attribute value included in an attribute that is not selected by the user, may be similar to each other. In such a case, in order for the user to grasp the feature unique to the analysis result from each of the analysis viewpoints, it is necessary to compare the analysis results. However, the text sorting device of Patent Literature 1 is incapable of recommending the user to compare the analysis results.

The present invention is accomplished with respect to the above-mentioned circumstances and is directed at providing a text mining device, a text mining system, a text mining method, and a recording medium, capable of recommending a user a combination of analysis viewpoints from which analysis results are to be compared.

### Solution to Problem

To achieve the above object, a text mining device according to first exemplary aspect of the present invention includes: an analysis unit which acquires, from data including text and one or more attributes including an attribute name and an attribute value and associated with the text, the attributes as analysis viewpoints, analyzes the data using the respective analysis viewpoints to obtain an analysis result from each analysis viewpoint, and generates result vectors of the respective analysis viewpoints; a similarity acquisition unit which acquires a vector similarity between the result vectors of the plural analysis viewpoints; and a recommendation unit which extracts and outputs a combination of the analysis viewpoints as a recommendation candidate on basis of the vector similarity.

A text mining system according to second exemplary aspect of the present invention includes: the text mining device according to the first exemplary aspect; and a data storage device in which the data is pre-stored.

A text mining method according to third exemplary aspect of the present invention includes: an analysis step for acquiring, from data including text and one or more attributes including an attribute name and an attribute value and associated with the text, the attributes as analysis viewpoints, analyzing the data using the respective analysis viewpoints to obtain an analysis result from each analysis viewpoint, and generating result vectors of the respective analysis viewpoints; a similarity acquisition step for acquiring a vector similarity between the result vectors of the plural analysis viewpoints; and a recommendation step for extracting and outputting a combination of the analysis viewpoints as a recommendation candidate on basis of the vector similarity.

A computer-readable recording medium according to fourth exemplary aspect of the present invention, in which a program is recorded for functionalizing a computer as: an analysis unit which acquires, from data including text and one or more attributes including an attribute name and an attribute value and associated with the text, the attributes as analysis viewpoints, analyzes the data using the respective analysis viewpoints to obtain an analysis result from each analysis viewpoint, and generates result vectors of the respective analysis viewpoints; a similarity acquisition unit which acquires a vector similarity between the result vectors of the plural analysis viewpoints; and a recommendation unit which extracts and outputs a combination of the analysis viewpoints as a recommendation candidate on basis of the vector similarity.

### Advantageous Effects of Invention

In accordance with the present invention, there can be provided a text mining device, a text mining system, a text mining method, and a recording medium, capable of recommending a user a combination of analysis viewpoints from which analysis results are to be compared.

### BRIEF DESCRIPTION OF DRAWINGS

FIG. 1 is a block diagram illustrating an example of the functional configuration of a text mining device according to an exemplary embodiment 1 of the present invention.

FIG. 2 is a view representing an example of data.

FIG. 3 is a flowchart representing an example of recommendation processing executed by the text mining device according to the exemplary embodiment 1 of the present invention.

FIG. 4 is a view representing an example of result data.

FIG. 5 is a block diagram illustrating a configuration example of a text mining system according to an exemplary embodiment 2 of the present invention.

FIG. 6 is a flowchart representing an example of recommendation processing executed by the text mining system according to the exemplary embodiment 2 of the present invention.

FIG. 7 is a block diagram illustrating an example of the hardware configurations of a text mining device and a data storage device.

### DESCRIPTION OF EMBODIMENTS

### Exemplary Embodiment 1

The functions and operation of a text mining device 100 will be explained in detail below with reference to the drawings. In the drawings, identical or equivalent elements are denoted by the same reference characters.

The text mining device 100 recommends a user a combination (recommendation candidate) of analysis viewpoints from which analysis results are to be compared. The user can grasp a feature unique to an analysis result from each analysis viewpoint by comparing the analysis results with each other from the analysis viewpoints included in the recommendation candidate (hereinafter referred to as analysis results from analysis viewpoints).

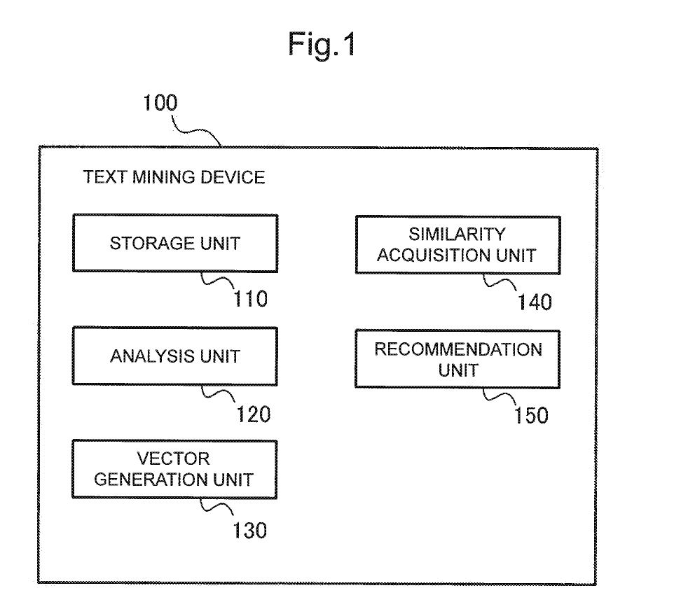

The text mining device 100 functionally includes a storage unit 110, an analysis unit 120, a vector generation unit 130, a similarity acquisition unit 140, and a recommendation unit 150, as illustrated in FIG. 1.

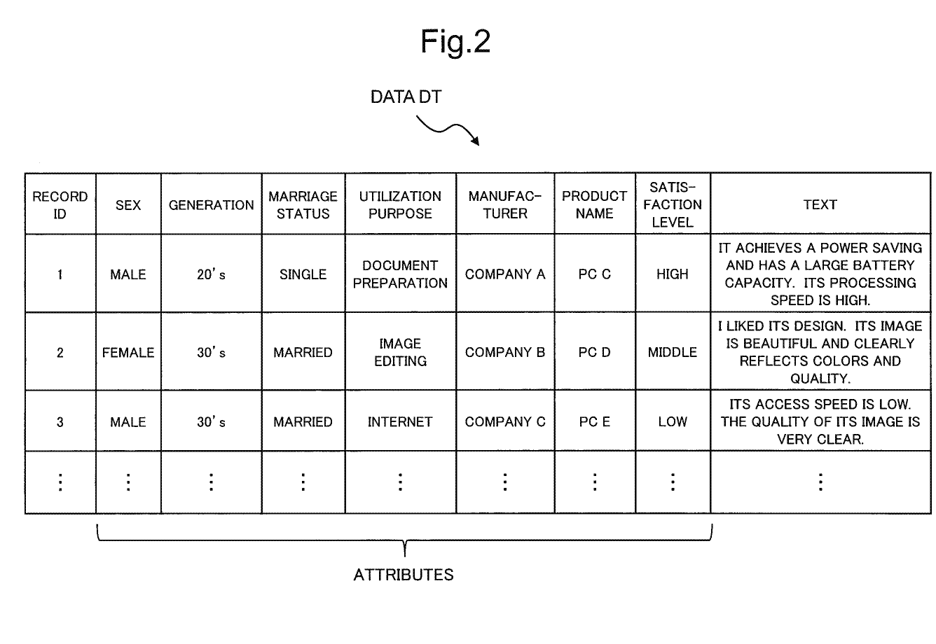

In the storage unit 110, data DT described as an exemplary example in FIG. 2 is pre-stored. The data DT is arbitrary data to be analyzed by the text mining device 100. The data DT is previously taken from an external input device (for example, a storage medium or a network), and stored in the storage unit 110.

The data DT includes a plurality of records as represented in FIG. 2. Each record includes a record ID, attributes, and text. A record ID, attributes, and text included in one record are associated with each other.

A record ID is an identifier for identifying each record.

An attribute includes an attribute name and attribute values. For example, the attributes of the data DT represented in FIG. 2 include “sex”, “generation”, “marriage status”, “utilization purpose”, “manufacturer”, “product name”, and “satisfaction level” as attribute names. The attribute including “sex” as an attribute name includes “male” and “female” as attribute values.

The analysis unit 120 acquires, as analysis viewpoints, the attribute values included in each attribute included in the data DT. The analysis unit 120 analyzes the data DT using each acquired analysis viewpoint and obtains an analysis result from each analysis viewpoint. The analysis unit 120 generates result data on the basis of the analysis result from each obtained analysis viewpoint.

The vector generation unit 130 generates each result vector of the analysis viewpoints on the basis of the result data generated by the analysis unit 120. The vector generation unit 130 generates combinations of the analysis viewpoints, including the plural analysis viewpoints obtained by the analysis unit 120. An analysis unit of claim 1 according to the present application is implemented in cooperation of the analysis unit 120 and the vector generation unit 130.

The similarity acquisition unit 140 acquires vector similarities between the result vectors of analysis viewpoints included in the respective combinations of the analysis viewpoints, generated by the vector generation unit 130.

Out of the combinations of the analysis viewpoints generated by the vector generation unit 130, the recommendation unit 150 extracts and displays, as recommendation candidates, a predetermined number of combinations having the highest vector similarities between the result vectors of the analysis viewpoints included in the combinations. The recommendation candidates are combinations of analysis viewpoints from which analysis results are to be compared by a user.

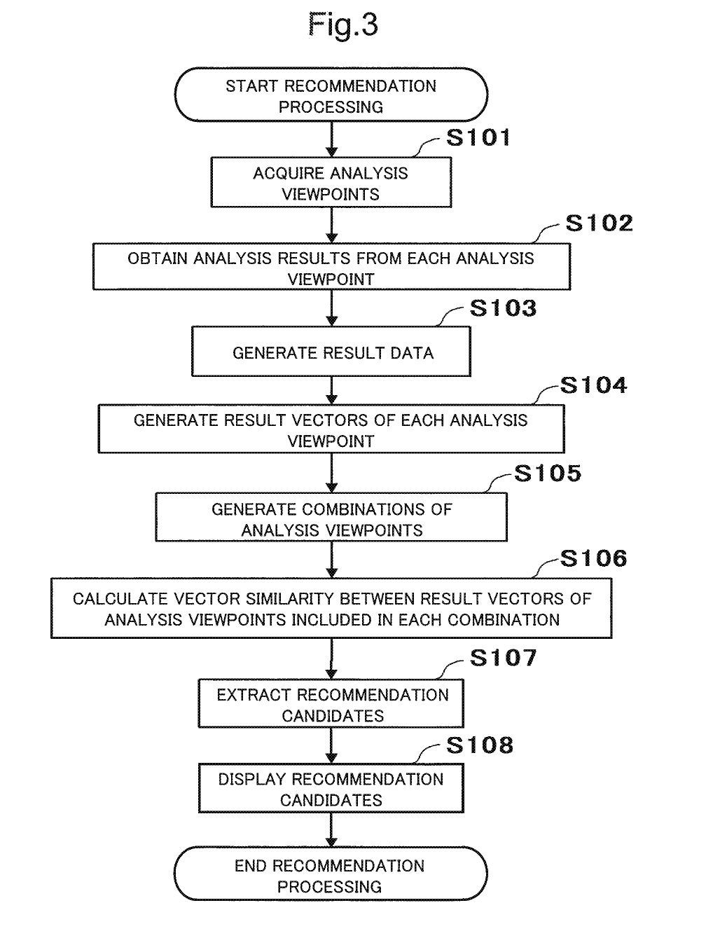

The operation of the text mining device 100 will be explained below using the flowchart of FIG. 3.

In the storage unit 110 included in the text mining device 100, the data DT desired to be subjected to text mining by a user is previously taken from an external input device, and stored.

The user selects a recommendation processing mode which is one of a plurality of operation modes included in the text mining device 100 when desiring the data DT to be subjected to text mining.

When the user selects the recommendation processing mode, the text mining device 100 starts recommendation processing represented in the flowchart of FIG. 3.

The analysis unit 120 acquires, as analysis viewpoints, attribute values included in each attribute included in the data DT (step S101).

The analysis unit 120 obtains analysis results from each analysis viewpoint (step S102).

Specifically, the analysis unit 120 extracts feature words from text associated with attribute values adopted as analysis viewpoints in the data DT and obtains the feature words as the analysis results from each analysis viewpoint. The feature words, which are words included in the text associated with the attribute values adopted as the analysis viewpoints in the data DT, are a pre-set predetermined number (50, in the present exemplary embodiment) of the words having the highest rates (weighted values) of the occurrence frequencies of the words in the text associated with the attribute values adopted as the analysis viewpoints to the occurrence frequencies of the words in all text included in the data DT.

The analysis unit 120 generates result data including the analysis results from each analysis viewpoint obtained in step S102 (step S103).

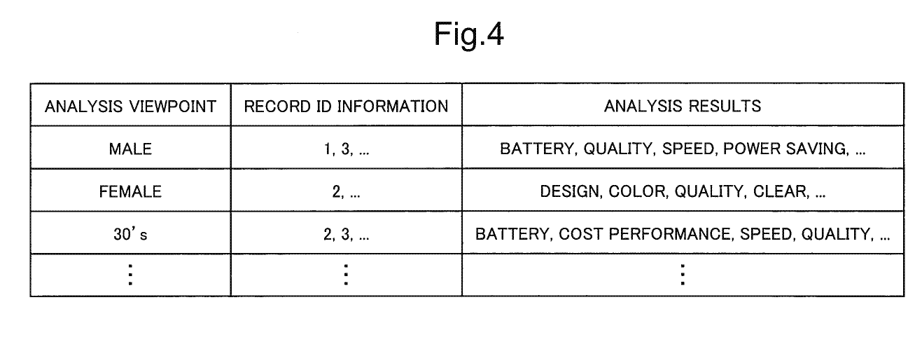

The result data includes analysis viewpoints (attribute values), record ID information, and the analysis results as represented in FIG. 4. The record ID information includes all record IDs associated with the attribute values adopted as the analysis viewpoints in the data DT. As represented in FIG. 2, the record IDs, the attributes, and the text are associated with each other in the data DT. Therefore, the record ID information representing all the record IDs associated with the attribute values adopted as the analysis viewpoints in the data can represent all the text associated with the attribute values adopted as the analysis viewpoints in the data.

For example, text associated with an attribute value “male” in the data DT described as an exemplary example in FIG. 2 includes words such as “power saving”, “battery”, “capacity”, “large” “processing”, and “speed”. The analysis unit 120 obtains, as analysis results in the case of adopting the attribute value “male” as the analysis viewpoint, words, such as “battery”, “quality”, “speed”, and “power saving”, which are 50 words (feature words) having the highest weighted values out of the words, as represented in FIG. 4. In the data DT described as the exemplary example in FIG. 2, record IDs “1”, “3”, and the like are associated with the attribute value “male”. Therefore, in the result data represented in FIG. 4, record ID information in the case of adopting the attribute value “male” as the analysis viewpoint includes the record IDs “1”, “3”, and the like.

The analysis unit 120 sends the generated result data to the vector generation unit 130.

The vector generation unit 130 generates the result vector of each analysis viewpoint on the basis of the result data received from the analysis unit 120 (step S104).

Specifically, the vector generation unit 130 applies a value of “1” to the elements of words (feature words) obtained as analysis results from certain analysis viewpoints in vectors including, as elements (members), all the words included in all the text included in the data DT, and applies a value of “0” to the other elements, to thereby generate the result vectors of the analysis viewpoints.

For example, the text included in the data DT includes words such as “design”, “color”, “battery”, “quality”, “speed”, and “power saving”, as represented in FIG. 2. It is assumed that the analysis results in the case of adopting the attribute value “male” as the analysis viewpoint include feature words such as “battery”, “quality”, “speed”, and “power saving” but include neither “design” nor “color”, as described as an exemplary example in FIG. 4. In this case, the vector generation unit 130 generates a vector of (design=0, color=0, battery=1, quality=1, speed=1, power saving=0, . . . ) as a result vector in the case of adopting the attribute value “male” as the analysis viewpoint.

Then, the vector generation unit 130 generates combinations of the analysis viewpoints including the plural analysis viewpoints acquired by the analysis unit 120 in step S101 (step S105).

The similarity acquisition unit 140 calculates the vector similarities between the result vectors of the respective analysis viewpoints included in the respective combinations (step S106).

Specifically, the similarity acquisition unit 140 regards, as sets, the result vectors of two analysis viewpoints that are different from each other, and calculates the Jaccard coefficient of the two sets as a vector similarity between the two vectors.

Assuming that the result vectors of two analysis viewpoints that are different from each other are regarded as sets A and B, respectively, a Jaccard coefficient J (A, B) is determined by the following equation (1).

$$\begin{matrix}[ Equation 1 ] & \\ J ( A , B ) = \frac{\vert A ⋂ B \vert}{\vert A ⋃ B \vert} = \frac{\vert A ⋂ B \vert}{\vert A \vert + \vert B \vert - \vert A ⋂ B \vert} & equation ( 1 )\end{matrix}$$

A∩B represents the product set of sets A and B, and A∪B represents the union of the sets A and B. |A| represents the number (original number, concentration) of elements in the set A. Similarly, |B|, |A∩B|, and |A∪B| represent the numbers of elements in the sets B, A∩B, and A∪B, respectively.

The recommendation unit 150 extracts, as recommendation candidates, a pre-set predetermined number of combinations having the highest vector similarities between the result vectors of the respective analysis viewpoints included in the combinations (step S107).

The recommendation unit 150 displays the recommendation candidates (step S108) and ends the recommendation processing.

As explained above, the text mining device 100 according to the present exemplary embodiment outputs, as recommendation candidates, combinations of analysis viewpoints having high vector similarities between the result vectors of respective analysis viewpoints. A user can compare analysis results, with each other, from a plurality of analysis viewpoints included in the recommendation candidates, to grasp differences between the analysis results, i.e., features unique to the analysis results from the respective analysis viewpoints.

In accordance with the present invention, recommendation candidates are output by the text mining device 100, and therefore, it is not necessary for a user himself/herself to select a combination of analysis viewpoints to be compared.

In accordance with the present invention, analysis results having the highest similarities can be preferentially compared with each other, and therefore, a user can efficiently grasp differences between analysis results, i.e., unique features.

In accordance with the present invention, in a case in which similar analysis results are obtained by adopting a plurality of attribute values that are different from each other as analysis viewpoints, respectively, combinations of the analysis viewpoints are output as recommendation candidates to a user even when the attribute values are attribute values included in attributes that are different from each other. Since analysis results in the case of adopting a plurality of attribute values included in attributes that are different from each other as analysis viewpoints, respectively, can be compared with each other, the user can accurately grasp features unique to analysis results from each analysis viewpoint.

In the present exemplary embodiment, the text mining device 100 analyzes the data DT having a structure represented in FIG. 2. The text mining device 100 can analyze data having an arbitrary structure as long as the data includes an attribute and text.

In the present exemplary embodiments, combinations of arbitrary analysis viewpoints from which analysis results are similar are output as recommendation candidates to a user. When the user selects a certain attribute value as an analysis target, the text mining device 100 can also output, as a recommendation candidate, an analysis viewpoint of which the analysis results are similar to analysis results in the case of adopting, as an analysis viewpoint, the attribute value selected as the analysis target. The user can grasp the unique feature of the attribute value of the analysis target by comparing the analysis results in the case of adopting, as the analysis viewpoint, the attribute value selected as the analysis target with the analysis results from the analysis viewpoint output as the recommendation candidate by the text mining device 100.

A combination of a plurality of attribute values may be specified as an analysis target. In this case, a combination of the attribute values included in a plurality of attributes that are different from each other can be specified as the analysis target.

The analysis unit 120 can individually acquire, as an analysis viewpoint, each attribute value included in the data DT, or can acquire, as an analysis viewpoint, a combination of a plurality of attribute values, or an attribute itself including an attribute name and an attribute value.

The similarity acquisition unit 140 may calculate a vector similarity by itself as in the present exemplary embodiment, or may acquire a vector similarity previously calculated by and stored in an external device.

In the present exemplary embodiment, the 50 feature words are obtained as the analysis results. The number of feature words obtained as analysis results can be arbitrarily set. Information excluding feature words may be obtained as an analysis result.

For example, the occurrence frequency or number of occurrences of each word in text associated with each analysis viewpoint may be obtained as an analysis result from each analysis viewpoint.

Alternatively, the occurrence frequency or number of occurrences of each phrase in text associated with each analysis viewpoint may be obtained as an analysis result from each analysis viewpoint. Such a phrase refers to a series of a plurality of words.

Alternatively, a predetermined number of phrases (feature phrases) having the highest weighted values, out of phrases occurring in text associated with each analysis viewpoint, may be obtained as analysis results from each analysis viewpoint.

Alternatively, modifications occurring in text associated with each analysis viewpoint, or the occurrence frequency or number of occurrences of each modification in text associated with each analysis viewpoint may be obtained as analysis results from each analysis viewpoint. Such a modification refers to a grammatical relation existing between a word or phrase and another word or phrase. For example, it is assumed that seven descriptions of which the contents are equivalent to “cost performance is high” or “high cost performance” occur in text associated with a certain analysis viewpoint. In this case, each of “cost performance & high” which is a modification and “7” which is the number of occurrences thereof is obtained as one of the analysis results from the analysis viewpoint.

In the present exemplary embodiment, result vectors are generated by applying a value of “1” to elements representing feature words included in analysis results from each analysis viewpoint, in the vectors including, as elements (members), all the words included in the text included in the data DT. A result vector can also be generated by a method different from the method described in the present exemplary embodiment.

For example, result vectors may be generated using not all but some of feature words obtained as analysis results.

Alternatively, result vectors may be generated using phrases or modifications obtained as analysis results.

Alternatively, when any one of the occurrence frequency or number of occurrences of a word, the occurrence frequency or number of occurrences of a phrase, and the occurrence frequency or number of occurrences of a modification is obtained as an analysis result from each analysis viewpoint, result vectors having, as elements, the occurrence frequencies or the occurrence frequencies may be generated.

Alternatively, a result vector including information excluding analysis results may be generated. For example, a result vector in the case of adopting an attribute value “male” as an analysis viewpoint can include, as the elements thereof, the attribute value “male” which is the analysis viewpoint and “sex” which is an attribute name included in an attribute including the attribute value “male”. A result vector may be generated using record ID information. For example, a result vector including, as an element, a record ID represented in the record ID information can be generated.

In the present exemplary embodiment, a Jaccard coefficient is adopted as a vector similarity. A similarity between sets, other than a Jaccard coefficient, may be adopted as a vector similarity.

For example, a co-occurrence frequency can be adopted as a vector similarity. Assuming that the result vectors of two analysis viewpoints that are different from each other are regarded as sets A and B, respectively, a co-occurrence frequency K (A, B) can be determined by the following equation (2).

[Equation 2]

K(A,B)=|A∩B| equation(2)

Alternatively, a cosine coefficient (cosine distance or cosine similarity) may be adopted as a vector similarity. A cosine coefficient C (A, B) can be determined by the following equation (3).

$$\begin{matrix}[ Equation 3 ] & \\ C ( A , B ) = \frac{\vert A ⋂ B \vert}{\sqrt{\vert A \vert \times \vert B \vert}} & equation ( 3 )\end{matrix}$$

Alternatively, a dice coefficient may be adopted as a vector similarity. A dice coefficient D (A, B) can be determined by the following equation (4).

$$\begin{matrix}[ Equation 4 ] & \\ D ( A , B ) = \frac{2 \vert A ⋂ B \vert}{\vert A \vert + \vert B \vert} & equation ( 4 )\end{matrix}$$

Alternatively, an overlap coefficient (Simpson coefficient) may be adopted as a vector similarity. An overlap coefficient S (A, B) can be determined by the following equation (5):

$$\begin{matrix}[ Equation 5 ] & \\ S ( A , B ) = \frac{\vert A ⋂ B \vert}{min ( \vert A \vert , \vert B \vert )} & equation ( 5 )\end{matrix}$$

wherein min (|A|, |B|) represents a lower value out of |A| and |B|.

In the present exemplary embodiment, a predetermined number of combinations having the highest similarities between the result vectors of the analysis viewpoints included in each combination are extracted as recommendation candidates. Instead of the extraction of a predetermined number of the combinations, a list in which all generated combinations are sorted in descending order of a similarity between the result vectors of analysis viewpoints included in each combination may be created and displayed.

When combinations extracted as recommendation candidates are displayed, an analysis result from each analysis viewpoint included in each combination may also be displayed together. Alternatively, when a user selects any one of analysis viewpoints included in combinations displayed as recommendation candidates, analysis results from the selected analysis viewpoint may be displayed.

When combinations extracted as recommendation candidates are displayed, the recommendation score of each combination may also be displayed together. The recommendation score is a score applied depending on a vector similarity between the result vectors of analysis viewpoints included in each combination.

Recommendation candidates may be displayed with a view such as a graph. Instead of displaying of the recommendation candidates on a display or the like, the recommendation candidates may be output to a user by a non-visual method such as voice.

### Exemplary Embodiment 2

In the exemplary embodiment 1, part of the recommendation processing executed by the text mining device 100 may be carried out by a device other than the text mining device 100. A text mining system 1000 in which recommendation processing is executed in cooperation of a text mining device 100 and a data storage device 200 will be explained below.

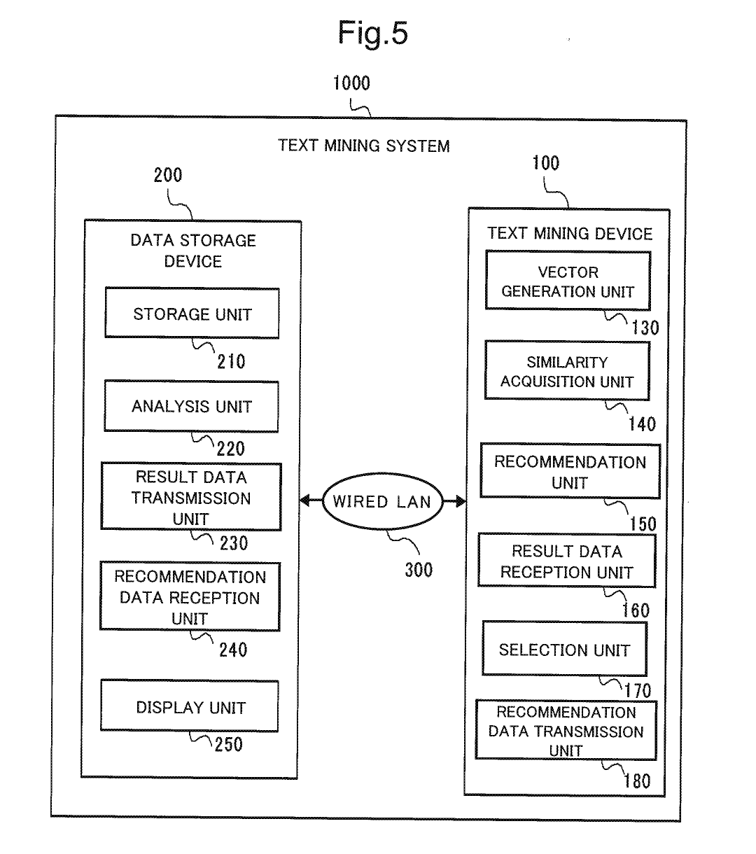

The text mining system 1000 includes the text mining device 100 and the data storage device 200 as illustrated in FIG. 5. The text mining device 100 and the data storage device 200 are connected to each other via a wired LAN (Local Area Network) 300.

The text mining device 100 functionally includes a vector generation unit 130, a similarity acquisition unit 140, a recommendation unit 150, a result data reception unit 160, a selection unit 170, and a recommendation data transmission unit 180, as illustrated in FIG. 5.

The functions and operations of the vector generation unit 130, the similarity acquisition unit 140, and the recommendation unit 150 are approximately similar to those in the first exemplary embodiment.

The result data reception unit 160 receives result data from a result data transmission unit 230 included in the data storage device 200 mentioned later.

The selection unit 170 extracts combinations satisfying a pre-set extraction condition, out of combinations of analysis viewpoints including a plurality of analysis viewpoints (attribute values) generated by the vector generation unit 130.

The recommendation data transmission unit 180 generates recommendation data representing recommendation candidates extracted by the recommendation unit 150 and transmits the recommendation data to a recommendation data reception unit 240 included in the data storage device 200 mentioned later.

In contrast, the data storage device 200 functionally includes a storage unit 210, an analysis unit 220, the result data transmission unit 230, the recommendation data reception unit 240, and a display unit 250, as illustrated in FIG. 5.

Like in the storage unit 110 included in the text mining device 100 of the exemplary embodiment 1, in the storage unit 210, data DT targeted for text mining is previously taken from an external input device, and stored.

The analysis unit 220 includes functions similar to those of the analysis unit 120 included in the text mining device 100 according to the first exemplary embodiment.

The result data transmission unit 230 transmits result data to the result data reception unit 160 included in the text mining device 100.

The recommendation data reception unit 240 receives the recommendation data from the recommendation data transmission unit 180 included in the text mining device 100.

The display unit 250 displays the recommendation candidates represented in the recommendation data.

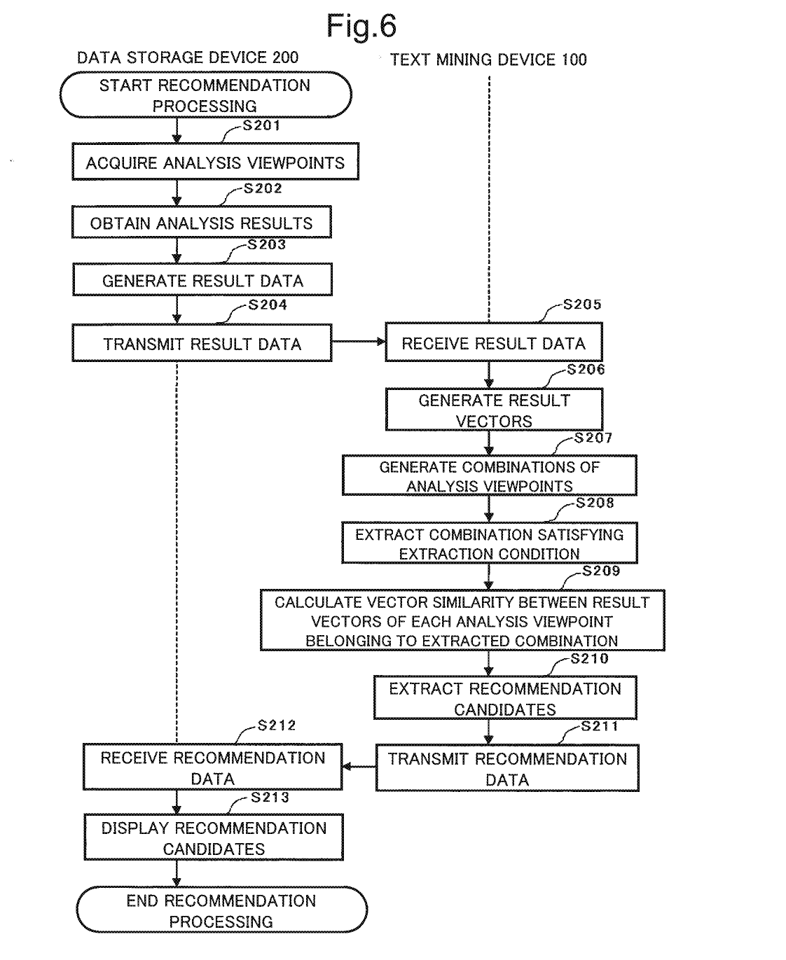

The operation of the text mining system 1000 will be explained below using the flowchart of FIG. 6.

In the storage unit 210 included in the data storage device 200, the data DT desired to be subjected to text mining by a user is previously taken from an external input device, and stored.

The user selects a recommendation processing mode which is one of a plurality of operation modes included in the data storage device 200 when desiring the data DT to be subjected to text mining.

When the user selects the recommendation processing mode, the data storage device 200 starts recommendation processing represented in the flowchart of FIG. 6.

The analysis unit 220 in the data storage device acquires, as analysis viewpoints, attribute values included in each attribute included in the data DT (step S201).

The analysis unit 220 obtains analysis results from each analysis viewpoint (step S202). Specifically, the analysis unit 220 extracts feature words from text associated with attribute values adopted as analysis viewpoints in the data DT and obtains the feature words as the analysis results from each analysis viewpoint.

The analysis unit 220 generates result data including the analysis results from each analysis viewpoint obtained in step S202 (step S203) and sends the result data to the result data transmission unit 230.

The result data transmission unit 230 transmits the received result data to the result data reception unit 160 in the text mining device 100 (step S204).

The result data reception unit 160 receives the result data (step S205) and sends the result data to the vector generation unit 130.

The vector generation unit 130 generates the result vector of each analysis viewpoint on the basis of the received result data (step S206). Specifically, the vector generation unit 130 applies a value of “1” to the elements of words (feature words) obtained as analysis results from certain analysis viewpoints in vectors including, as elements (members), all the words included in all the text included in the data DT, and applies a value of “0” to the other elements, to thereby generate the result vectors of the analysis viewpoints.

Then, the vector generation unit 130 generates combinations of the analysis viewpoints including the plural analysis viewpoints (attribute values) (step S207), and sends the combinations to the selection unit 170.

The selection unit 170 extracts combinations satisfying a pre-set extraction condition, out of the received combinations of the analysis viewpoint (step S208).

Specifically, the selection unit 170 extracts, out of the combinations generated in step S207, combinations with elements included in common in the result vectors of the respective analysis viewpoints included in the combinations, in which the number of elements having a value of “1” is not less than a predetermined number. As a result, the selection unit 170 can extract only combinations of analysis viewpoints of which the result vectors are similar to each other at not less than a certain level.

The similarity acquisition unit 140 calculates a vector similarity (Jaccard coefficient) between the result vectors of the respective analysis viewpoints included in the combinations extracted in step S208 (step S209).

The recommendation unit 150 extracts, as recommendation candidates, a pre-set predetermined number of combinations having the highest vector similarities between the result vectors of the respective analysis viewpoints included in the combinations (step S210).

The recommendation data transmission unit 180 generates recommendation data representing the recommendation candidates extracted in step S210 and transmits the recommendation data to the recommendation data reception unit 240 in the data storage device 200 (step S211).

The recommendation data reception unit 240 receives the recommendation data (step S212) and sends the recommendation data to the display unit 250. The display unit 250 displays the recommendation candidates represented by the received recommendation data (step S213) and ends the recommendation processing.

A user can grasp features unique to analysis results from each analysis viewpoint by comparing the analysis results from each analysis viewpoint included in combinations of analysis viewpoints output as recommendation candidates by the text mining system 1000 according to the present exemplary embodiment.

In the present exemplary embodiment, part (storage of data DT, acquisition of analysis viewpoints, obtaining analysis results, generation of result data, and displaying of recommendation candidates) of the recommendation processing executed by the text mining device 100 in Exemplary Embodiment 1 is executed by the data storage device 200. Therefore, a processing load according to the text mining device 100 according to the present exemplary embodiment is smaller than a processing load according to the text mining device 100 according to Exemplary Embodiment 1.

The text mining device 100 according to the present exemplary embodiment extracts combinations satisfying a pre-set extraction condition, out of combinations of generated analysis viewpoints, and calculates vector similarities between the result vectors of only the respective analysis viewpoints included in the extracted combinations. Therefore, a processing load according to the text mining device 100 according to the present exemplary embodiment is smaller than a processing load according to the text mining device 100 according to Exemplary Embodiment 1, which calculates vector similarities between the result vectors of the respective analysis viewpoints included in all generated combinations.

The text mining system 1000 according to the present exemplary embodiment extracts combinations of analysis viewpoints with elements included in common in the result vectors of respective analysis viewpoints included in the combinations, in which the number of elements having a value of “1” is not less than a predetermined number, and outputs, as recommendation candidates, part of the extracted combinations to a user. In other words, combinations in which analysis results from the analysis viewpoints included in the combinations are similar to each other at not less than a certain level are output as the recommendation candidates to the user. The user easily grasps the unique feature of each analysis viewpoint because of being able to compare the analysis results that are similar to each other at not less than the certain level.

In the present exemplary embodiment, out of the processing executed by the text mining device 100 in Exemplary Embodiment 1, the storage of data DT, the acquisition of analysis viewpoints, the obtaining analysis results, the generation of result data, and the displaying of recommendation candidates are executed by the data storage device 200, and the other processing is executed by the text mining device 100. Various shares of functions, different from the share of the functions, described in the present exemplary embodiment, are possible.

For example, the displaying of recommendation candidates based on recommendation data may be carried out by the text mining device 100.

Alternatively, the data storage device 200 may carry out the generation of result vectors, and the extraction of combinations of analysis viewpoints satisfying the extraction condition, to thereby reduce a processing load on the text mining device 100. In this case, the data storage device 200 transmits, to the text mining device 100, the extracted combinations of the analysis viewpoint, and the result vectors of the respective analysis viewpoints included in the combinations. Since only information about the extracted analysis viewpoints is transmitted, the efficiency of the operation of the entire text mining system 1000 is improved compared to the case of transmitting result data for all analysis viewpoints as in the present exemplary embodiment.

In the present exemplary embodiment, the text mining device 100 adopts “with elements included in common in the result vectors of respective analysis viewpoints included in the combinations, in which the number of elements having a value of “1” is not less than a predetermined number” as the extraction condition used for extracting combinations of analysis viewpoints. Combinations of analysis viewpoints may be extracted using an arbitrary condition different from the condition described in the present exemplary embodiment.

For example, “a simple similarity between analysis results from each analysis viewpoint included in the combinations is not less than a predetermined threshold value” may be adopted as an extraction condition. Such a simple similarity is an arbitrary similarity that is more easily obtained than a vector similarity. The simple similarity is, for example, an inner product or distance between the result vectors of respective analysis viewpoints.

Alternatively, “with elements included in common in the result vectors of respective analysis viewpoints included in the combinations, in which the number of elements having a value greater than a predetermined threshold value is not less than a predetermined number” may be adopted as an extraction condition. For example, when result vectors include, as elements, the occurrence frequencies of words, combinations of analysis viewpoints sharing not less than a predetermined number of words of which the occurrence frequencies are higher than a predetermined threshold value are extracted as combinations satisfying the extraction condition. It can be estimated that words that frequently occur in analysis results are words representing the features of the analysis results. A user can efficiently grasp the unique feature of each analysis viewpoint by comparing analysis results in which the words representing the features are common.

Alternatively, “a record similarity between respective analysis viewpoints included in the combinations is not more than a predetermined threshold value” may be adopted as an extraction condition. Such a record similarity is a similarity between items of record ID information. Specifically, the number of record IDs included in common in the record ID information of analysis viewpoints that are different from each other, or the rate (sharing rate) of the number of the record IDs included in common in the record ID information of the analysis viewpoints that are different from each other to the total number of record IDs included in the record ID information of the respective analysis viewpoints can be adopted as a record similarity. For example, it is assumed that in the present exemplary embodiment, all men who responded to a questionnaire were thirtysomething. In this case, it can be estimated that there is a high similarity between an analysis result in the case of adopting an attribute value “male” as an analysis viewpoint and an analysis results in the case of regarding an attribute value “30's” as an analysis viewpoint. However, the similarity is only a false similarity that is produced by sample bias. A user may mistakenly recognize the feature of each analysis viewpoint by comparing two analysis results having a false similarity. False similarities between analysis results, produced due to sample bias, can be eliminated by eliminating combinations of analysis viewpoints having extremely high record similarities.

In the present exemplary embodiment, the single condition is adopted as an extraction condition. Combinations of plural conditions may be adopted as extraction conditions. When the plural conditions are adopted as extraction conditions, overall processing time can be shortened by setting order of narrowing (order of filtering) depending on each condition in consideration of time required for each narrowing, a degree of selectivity depending on each narrowing, and the like.

A combination of analysis viewpoints that satisfy an extraction condition can be extracted by methods disclosed in NPL 1 (Kenji Tateishi and one author, “Fast Duplicated Documents Detection with Multi-level Prefix-filter”, [online], The Database Society of Japan, [searched on Dec. 12, 2012], the Internet (URL: www.dbsj.org/journal/vol5/no4/tateishi.pdf)) and NPL 2 (Naoaki Okazaki and one author, “A Simple and Fast Algorithm for Approximate String Matching with Set Similarity”, [online], [searched on Dec. 12, 2012], the Internet (URL: www.chokkan.org/publication/okazaki_jnlp2011.pdf)). According to the methods disclosed in Non Patent Literatures 1 and 2, a combination that satisfies an extraction condition can be fast extracted without actually calculating a similarity between result vectors.

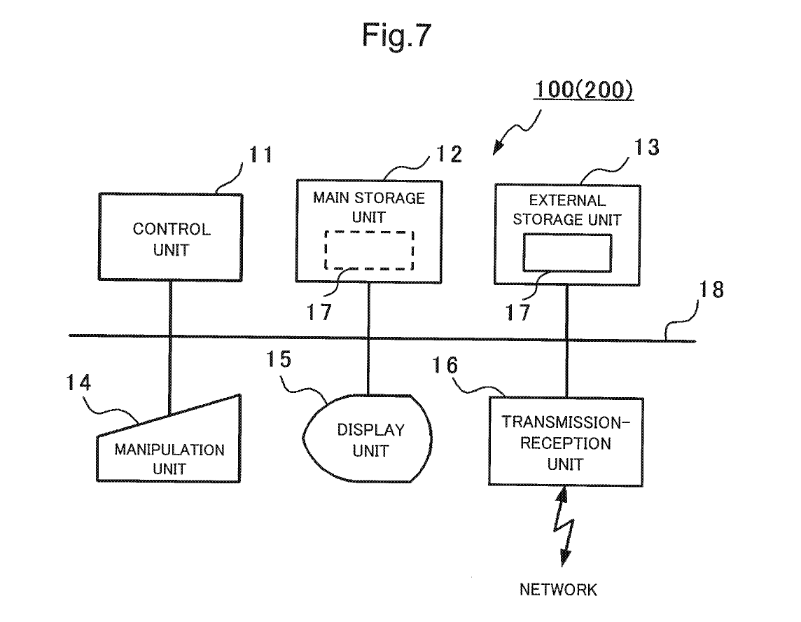

The text mining device 100 and the data storage device 200, including the above-mentioned functional configuration and carrying out the above-mentioned recommendation processing, includes a control unit 11, a main storage unit 12, an external storage unit 13, a manipulation unit 14, a display unit 15, a transmission-reception unit 16, and an internal bus 18 for connected them to each other, as a hardware configuration, as illustrated in FIG. 7.

The control unit 11 includes a CPU (Central Processing Unit). The control unit 11 controls the entire text mining device 100 and data storage device 200 to implement the above-mentioned various functions included in the text mining device 100 and the data storage device 200 by executing a control program 17 stored in the external storage unit 13. The analysis unit 120, the vector generation unit 130, the similarity acquisition unit 140, the recommendation unit 150, and the selection unit 170 in the text mining device 100 are implemented by the control unit 11. The analysis unit 220 in the data storage device 200 is also implemented by the control unit 11.

The main storage unit 12 includes a RAM (Random-Access Memory). The main storage unit 12 functions as a work area for the control unit 11, and various programs including the control program 17 and a text mining program are temporarily expanded in the main storage unit 12.

The external storage unit 13 includes a nonvolatile memory (for example, a flash memory, a hard disk, DVD-RAM (Digital Versatile Disc Random-Access Memory), DVD-RW (Digital Versatile Disc ReWritable, or the like). The external storage unit 13 fixedly stores various programs including the control program 17 executed by the control unit 11 and the text mining program, as well as various fixed data. The external storage unit 13 supplies stored data to the control unit 11 and stores data supplied from the control unit 11. The storage unit 110 in the text mining device 100 and the storage unit 210 in the data storage device 200 are implemented by the external storage unit 13.

The manipulation unit 14 includes a keyboard and a mouse, and accepts a manipulation by a user.

The display unit 15 displays a variety of information including recommendation candidates. The display unit 15 includes, for example, a CRT (Cathode Ray Tube) or an LCD (Liquid Crystal Display). The display unit 250 in the data storage device 200 is implemented by the display unit 15.

The transmission-reception unit 16 includes: a network termination device or wired communication device connected to a network; and a serial interface or LAN interface connected to the device. The result data reception unit 160 and the recommendation data transmission unit 180 in the text mining device 100, and the result data transmission unit 230 and the recommendation data reception unit 240 in the data storage device 200 are implemented by the transmission-reception unit 16.

The internal bus 18 connects the control unit 11 to the transmission-reception unit 16 to each other.

The text mining device 100 and the data storage device 200 can be implemented, without a dedicated system, using a normal computer system. The text mining device 100 and the data storage device 200, executing the above-mentioned processing, may be configured, for example, by distributing a computer-readable recording medium (flexible disk, CD-ROM, DVD-ROM, or the like) in which a computer program for executing the operation of the text mining device 100 and the data storage device 200 is stored and by installing the computer program on a computer. The text mining device 100 and the data storage device 200 may be configured by, e.g., downloading, into a normal computer system, the computer program, which is stored in a storage device included in a server device on a communication network such as the Internet.

When the various functions of the text mining device 100 and the data storage device 200 are implemented by sharing by an OS (operating system) and an application program, or in cooperation of the OS and the application program, only the application portion may be stored in the external storage unit 13, a recording medium, a storage device, or the like.

An application program can be superimposed on carrier waves and delivered via a communication network. For example, the application program may be posted on a bulletin board (BBS: Bulletin Board System) on the communication network and delivered via the network. Such a configuration may be made that the processing can be executed by starting the application program installed on a computer and by executing the application program under the control of an OS in a manner similar to that of another application program.

In addition, each of the hardware configurations, flowcharts, threshold values, parameters, and the like described above is only an example, and can be optionally changed and modified.

Some or all of the exemplary embodiments described above can also be described as in the following supplemental notes but are not limited to the following.

(Supplemental Note 1)

A text mining device including:

an analysis unit which acquires, from data including text and one or more attributes including an attribute name and an attribute value and associated with the text, the attributes as analysis viewpoints, analyzes the data using the respective analysis viewpoints to obtain an analysis result from each analysis viewpoint, and generates result vectors of the respective analysis viewpoints;

a similarity acquisition unit which acquires a vector similarity between the result vectors of the plural analysis viewpoints; and

a recommendation unit which extracts and outputs a combination of the analysis viewpoints as a recommendation candidate on basis of the vector similarity.

(Supplemental Note 2)

The text mining device according to Supplemental Note 1, wherein

the result vectors are generated on basis of one or more items of data included in the analysis result from each of the analysis viewpoints.

(Supplemental Note 3)

The text mining device according to Supplemental Note 1 or 2, wherein

the analysis result from each of the analysis viewpoints includes at least any one of a word included in the text, an occurrence frequency of the word included in the text, a number of occurrences of the word included in the text, a modification included in the text, and a phrase included in the text.

(Supplemental Note 4)

The text mining device according to any one of Supplemental Notes 1 to 3, further including a selection unit which extracts a combination of analysis viewpoints satisfying an extraction condition, out of combinations of the analysis viewpoints, wherein

the similarity acquisition unit acquires a vector similarity between result vectors of analysis viewpoints included in a combination of respective analysis viewpoints in the combination of the analysis viewpoints extracted by the selection unit.

(Supplemental Note 5)

The text mining device according to Supplemental Note 4, wherein

the extraction condition includes at least any one of conditions of: a combination of analysis viewpoints, in which a simple similarity between result vectors of analysis viewpoints included in the combination of the analysis viewpoints is higher than a predetermined threshold value; elements included in common in result vectors of analysis viewpoints included in the combination of the analysis viewpoints, in which the number of elements having a value that is not less than a predetermined threshold value is not less than a predetermined number; and a similarity between items of identification information representing text associated with each analysis viewpoint, which similarity is not more than a predetermined threshold value between items of identification information of analysis viewpoints included in the combination of the analysis viewpoints.

(Supplemental Note 6)

A text mining system including:

the text mining device according to any one of Supplemental Notes 1 to 5; and

a data storage device in which the data is pre-stored.

(Supplemental Note 7)

A text mining method including:

an analysis step for acquiring, from data including text and one or more attributes including an attribute name and an attribute value and associated with the text, the attributes as analysis viewpoints, analyzing the data using the respective analysis viewpoints to obtain an analysis result from each analysis viewpoint, and generating result vectors of the respective analysis viewpoints;

a similarity acquisition step for acquiring a vector similarity between the result vectors of the plural analysis viewpoints; and

a recommendation step for extracting and outputting a combination of the analysis viewpoints as a recommendation candidate on basis of the vector similarity.

(Supplemental Note 8)

A computer-readable recording medium in which a program is recorded for functionalizing a computer as:

an analysis unit which acquires, from data including text and one or more attributes including an attribute name and an attribute value and associated with the text, the attributes as analysis viewpoints, analyzes the data using the respective analysis viewpoints to obtain an analysis result from each analysis viewpoint, and generates result vectors of the respective analysis viewpoints;

a similarity acquisition unit which acquires a vector similarity between the result vectors of the plural analysis viewpoints; and

a recommendation unit which extracts and outputs a combination of the analysis viewpoints as a recommendation candidate on basis of the vector similarity.

Various exemplary embodiments and modifications can be made without departing from the broader spirit and scope of the present invention. It should be noted that the above embodiments are meant only to be illustrative of the present invention and are not intended to be limiting the scope of the present invention. Accordingly, the scope of the present invention should not be determined by the embodiments illustrated, but by the appended claims. It is therefore the intention that the present invention be interpreted to include various modifications that are made within the scope of the claims and their equivalents.

The present application is based on Japanese Patent Application No. 2013-003990 filed on Jan. 11, 2013. The specification, claims, and drawings of Japanese Patent Application No. 2013-003990 are incorporated herein by reference in their entirety.

### INDUSTRIAL APPLICABILITY

The present invention enables a user to grasp a feature unique to an analysis result from each analysis viewpoint in text mining. Therefore, the present invention is useful in a field such as marketing, which demands extraction of useful information from enormous text data such as questionnaire results.

### REFERENCE SIGNS LIST

11 Control unit
12 Main storage unit
13 External storage unit
14 Manipulation unit
15 Display unit
16 Transmission-reception unit
17 Control program
18 Internal bus
100 Text mining device
110 Storage unit
120 Analysis unit
130 Vector generation unit
140 Similarity acquisition unit
150 Recommendation unit
160 Result data reception unit
170 Selection unit
180 Recommendation data transmission unit
200 Data storage device
210 Storage unit
220 Analysis unit
230 Result data transmission unit
240 Recommendation data reception unit
250 Display unit
300 Wired LAN
1000 Text mining system

What is claimed is:

1. A text mining device comprising:
an analysis unit configured to acquire, from data including text and one or more attributes including an attribute name and an attribute value and associated with the text, the attributes as analysis viewpoints, analyze the data using the respective analysis viewpoints to obtain an analysis result from each analysis viewpoint, and generate result vectors of the respective analysis viewpoints;
a similarity acquisition unit configured to acquire a vector similarity between the result vectors of the plural analysis viewpoints; and
a recommendation unit configured to extract and output a combination of the analysis viewpoints as a recommendation candidate on basis of the vector similarity.

2. The text mining device according to claim 1, wherein
the result vectors are generated on basis of one or more items of data included in the analysis result from each of the analysis viewpoints.

3. The text mining device according to claim 1, wherein
the analysis result from each of the analysis viewpoints includes at least any one of a word included in the text, an occurrence frequency of the word included in the text, a number of occurrences of the word included in the text, a modification included in the text, and a phrase included in the text.

4. The text mining device according to claim 1, further comprising a selection unit configured to extract a combination of analysis viewpoints satisfying an extraction condition, out of combinations of the analysis viewpoints, wherein
the similarity acquisition unit acquires a vector similarity between result vectors of analysis viewpoints included in a combination of respective analysis viewpoints in the combination of the analysis viewpoints extracted by the selection unit.

5. The text mining device according to claim 4, wherein
the extraction condition includes at least any one of conditions of: a combination of analysis viewpoints, in which a simple similarity between result vectors of analysis viewpoints included in the combination of the analysis viewpoints is higher than a predetermined threshold value; elements included in common in result vectors of analysis viewpoints included in the combination of the analysis viewpoints, in which the number of elements having a value that is not less than a predetermined threshold value is not less than a predetermined number; and a similarity between items of identification information representing text associated with each analysis viewpoint, which similarity is not more than a predetermined threshold value between items of identification information of analysis viewpoints included in the combination of the analysis viewpoints.

6. (canceled)

7. A text mining method comprising:
acquiring, from data including text and one or more attributes including an attribute name and an attribute value and associated with the text, the attributes as analysis viewpoints, analyzing the data using the respective analysis viewpoints to obtain an analysis result from each analysis viewpoint, and generating result vectors of the respective analysis viewpoints;
acquiring a vector similarity between the result vectors of the plural analysis viewpoints; and
extracting and outputting a combination of the analysis viewpoints as a recommendation candidate on basis of the vector similarity.

8. A non-transitory computer-readable recording medium in which a program is recorded for functionalizing a computer as:
an analysis unit which acquires, from data including text and one or more attributes including an attribute name and an attribute value and associated with the text, the attributes as analysis viewpoints, analyzes the data using the respective analysis viewpoints to obtain an analysis result from each analysis viewpoint, and generates result vectors of the respective analysis viewpoints;
a similarity acquisition unit which acquires a vector similarity between the result vectors of the plural analysis viewpoints; and
a recommendation unit which extracts and outputs a combination of the analysis viewpoints as a recommendation candidate on basis of the vector similarity.
